(19) United States
(12) Patent Application Publication
(10) Pub. No.: US 2025/0357469 A1
(43) Pub. Date: Nov. 20, 2025

(54) RECHARGEABLE LITHIUM ION BATTERY HAVING A BENDABLE SILICON-GRAPHITE COMPOSITE ANODE

(71) Applicant: GM Global Technology Operations LLC, Detroit, MI (US)

(72) Inventors: Zhe Li, Shanghai (CN); Haijing Liu, Shanghai (CN)

(21) Appl. No.: 18/668,702

(22) Filed: May 20, 2024

(30) Foreign Application Priority Data
May 14, 2024 (CN) 202410598249.0

(51) Int. Cl. H01M 4/36; H01M 4/02; H01M 4/133; H01M 4/134; H01M 4/38; H01M 4/587; H01M 4/62; H01M 4/66; H01M 10/0525

(52) U.S. Cl. CPC H01M 4/366; H01M 4/133; H01M 4/134; H01M 4/386; H01M 4/587; H01M 4/625; H01M 4/661; H01M 10/0525; H01M 2004/021; H01M 2004/027

(57) ABSTRACT

A bendable silicon-graphite composite anode for a lithium ion battery cell is disclosed. The anode includes a current collector, a lithium-accepting host material, and a transition layer sandwiched between the current collector and the lithium-accepting host material. The transition layer is in direct contact with the current collector and the lithium-accepting host material. The transition layer includes graphite active material and a binder. The lithium-accepting host material is a layer of silicon having a homogenous thickness. The current collector is a metallic foil having thickness less than traditional anode current collectors.

### CROSS-REFERENCE TO RELATED APPLICATIONS

This application claims the benefit of foreign priority under 35 U.S.C. § 119 of Chinese patent application number 202410598249.0, filed on May 14, 2024. The contents of this application are incorporated herein by reference in their entirety.

### INTRODUCTION

The present disclosure relates to rechargeable lithium ion batteries, particularly to a rechargeable lithium ion battery having a silicon composite anode, and more particularly to a bendable silicon-graphite composite anode.

Rechargeable lithium ion batteries have the ability to hold a relatively high energy density, a relatively low internal resistance, and a low self-discharge rate when not in use as compared to older types of rechargeable batteries such as nickel metal hydride, nickel cadmium, or lead acid batteries. Electric and hybrid vehicles predominantly use rechargeable lithium ion batteries as a dependable power source due to the lithium ion batteries' ability to undergo repeated power cycling over their useful lifetimes.

Thus, while rechargeable lithium batteries achieve their intended purpose for use in electric and hybrid vehicles, there is a need for continuous improvement to enhance the performance, operational life, and manufacturability of the batteries.

### SUMMARY

According to several aspects, a battery cell having a bendable Si composite electrode is disclosed. The electrode includes a metallic foil, a silicon layer, and an active transition layer sandwiched between the metallic foil and the silicon layer. The active transition layer is in direct contact with the metallic foil and silicon layer.

In an additional aspect of the present disclosure, the electrode includes a graphite active material and a binder.

In another aspect of the present disclosure, the electrode includes at least one of a carbonaceous material, a metal oxide, a metal sulfide, and Li₄Ti₅O₁₂, and a binder.

In another aspect of the present disclosure, the binder includes at least one of poly(vinylidene fluoride) (PVDF), poly(vinylidene fluoride-co hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

In another aspect of the present disclosure, the electrode further includes a conductive additive at least one of: carbon black, graphite, graphene, graphene oxide, Super P, acetylene black, carbon nanofibers, and carbon nanotubes.

In another aspect of the present disclosure, the metallic foil includes a thickness of 1 μm to less than 5 μm, the silicon layer includes a thickness of 1 μm to 20 μm, and the transition layer includes a thickness of 2 μm to 50 μm.

In another aspect of the present disclosure, the Si layer includes a substantially homogenous thickness conforming to a contour of the transition layer.

In another aspect of the present disclosure, the electrode is a negative electrode. The graphite transition layer includes an areal capacity loading of greater than 0 to 5 mAh/cm². The Si layer includes an areal capacity loading of about 4 mAh/cm².

In another aspect of the present disclosure, the metallic foil includes a non-roughened surface in direct contact with the transition layer. The binder bonds the transition layer onto the non-roughened surface.

In another aspect of the present disclosure, the layer Si is deposited directly onto the graphite transition layer using a magnetron sputtering process to effectuate an intimate bond with the transition layer.

According to several aspects, an electrode for a rechargeable battery is disclosed. The electrode includes a current collector, a lithium-accepting host material, and a transition layer sandwiched between the current collector and the lithium-accepting host material. The transition layer includes a first surface in direct contact with the current collector and an opposite second surface in direct contact with the lithium-accepting host material.

In an additional aspect of the present disclosure, the lithium-accepting host material is a silicon layer.

In another aspect of the present disclosure, the current collector is a metallic foil comprising at least one of copper (Cu), Aluminum (AI), nickel (Ni), iron (Fe), titanium (Ti), and any alloys thereof including stainless steel. In another aspect of the present disclosure, the transition layer includes a graphite active material and a binder. The binder includes at least one of poly(vinylidene fluoride) (PVDF), poly(vinylidene fluoride-co hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

In another aspect of the present disclosure, the electrode further includes a conductive additive such as carbon black, graphite, graphene, graphene oxide, Super P, acetylene black, carbon nanofibers, and carbon nanotubes.

In another aspect of the present disclosure, wherein the layer of silicon includes a homogenous thickness of 1 μm to 20 μm, the transition layer includes a thickness of 2 μm to 50 μm, and the current collector includes a thickness of 1 μm to less than 5 μm.

According to several aspects, an electrode for a rechargeable battery is disclosed. The electrode includes a current collector, a silicon layer, and a graphite transition layer sandwiched between the current collector and the silicon layer. The graphite transition layer is in direct contact with the current collector and the current collector. The graphite transition layer includes a binder.

In an additional aspect of the present disclosure, the silicon layer includes a substantially homogenous thickness of 1 μm to 20 μm, the current collector includes a thickness between 1 μm to less than 5 μm, and the current collector includes a thickness of 1 μm to less than 5 μm.

In another aspect of the present disclosure, the graphite transition layer includes an areal capacity loading of greater than 0 to 5 mAh/cm² and the Si layer 20 includes an areal capacity loading of about 4 mAh/cm².

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic representation of a cross-section of a rechargeable lithium ion battery, according to an exemplary embodiment;

FIG. 2 is diagrammatic representation of a cross-section of a bendable silicon composite anode, according to an exemplary embodiment;

FIG. 3 is micrograph image of a cross-section of a bendable silicon-graphite composite anode, according to an exemplary embodiment;

FIG. 4 is a block diagram of a method of making the bendable silicon-graphite composite anode, according to an exemplary embodiment; and

FIGS. 5A-5C are graphs showing the improved performance of the bendable silicon-graphite composite anode as compared to a traditional anode having a silicon layer in direct contact with the current collector.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

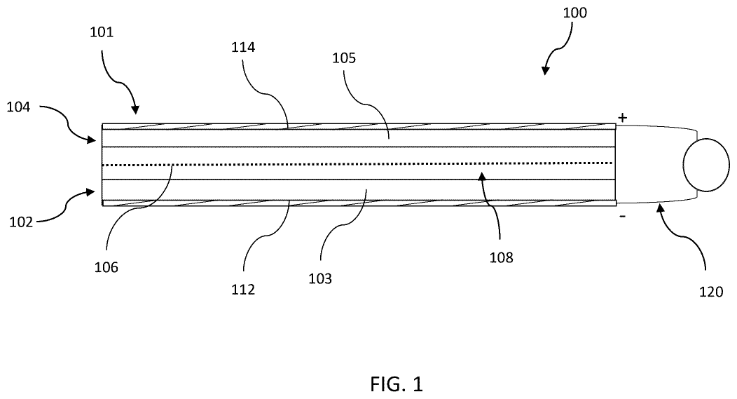

FIG. 1 is a diagrammatic representation of a rechargeable lithium ion battery, generally indicated by reference number 100. The rechargeable lithium ion battery 100 includes at least one battery cell 101. The battery cell 101 includes a negative electrode 102, a positive electrode 104, a porous separator layer 106 separating the negative electrode 102 and the positive electrode 104, and an electrolyte material 108 suitable for conducting lithium ions between the negative electrode 102 and the positive electrode 104 through the porous separator layer 106.

The negative electrode 102 includes a lithium accepting host material 103 and the positive electrode 104 includes a lithium-based active material 105 that can store lithium ions at a higher electric potential than the lithium accepting host material 103 of the negative electrode 102. The negative electrode 102 is also referred to as an anode 102 and the positive electrode 104 is also referred to as a cathode 104. Each of the negative electrode 102 and the positive electrode 104 is accommodated by a respective current collector 112, 114. The current collectors 112, 114 may be connected by an interruptible circuit 120 that allows an electrical current to pass between the negative and positive electrodes 102, 104 to electrically balance the related migration of the lithium ions between the negative and positive electrodes 102, 104 through the electrolyte material 108.

The rechargeable lithium battery 100 may be manufactured by stacking a plurality of battery cells 101 or by folding or rolling a continuous length of the battery cell 101 to achieve a desired battery voltage, energy storage, and power output. Roll-to-roll (R2R) manufacturing process, also known as reel-to-reel and web process, is an efficient method of mass producing a rechargeable lithium ion battery by continuously folding or rolling a predetermined length of battery cell 101 into a completed battery. The components of the battery cell 101, such as the negative electrode 102 or anode 102, need to be sufficiently flexible or bendable for the R2R manufacturing process.

Typical anode current collectors 112 are formed of an electrically conductive material such as a metallic foil having a thickness of about 5-24 microns or micrometer (μm). Silicon (Si) is a suitable anode lithium-accepting host material due to its abundance in nature, high room temperature specific capacity, and moderate lithiation potential of about 0.3 V vs Li/Li⁺. A layer of Si is typically deposited directly onto a pre-roughened surface of a sheet of metallic foil by using a scalable and controllable physical vapor deposition approach. The pre-roughened surface includes a roughness (Rz) of about 8 μm.

It was found that during the R2R process, by continuously folding or rolling a predetermined length of battery cell 101 into a completed battery 100, the Si layer bends at a different radius than the metallic foil, thereby possibly causing the Si layer to pull away from the roughened surface of the sheet of metallic foil. The bendable silicon composite anode 200 of the present disclosure solves the issue with the Si anode layer pulling away and detaching from the metallic foil during the R2R manufacturing process by employing an active transition layer, preferably a graphite transition layer, sandwiched between a Si layer and a planar metallic foil that is thinner than the roughened metallic foil used for the direct deposit of the Si Layer. The active transition layer provides an additional areal capacity for the battery cell 101 and the relatively thinner metallic foil enables greater bendability than the traditional thicker metallic foil used as anode current collectors.

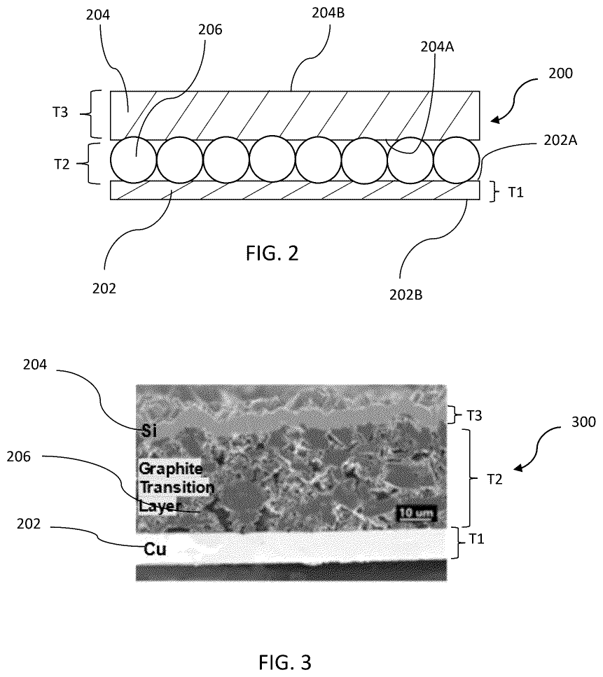

FIG. 2 is diagrammatic representation of a cross section of a bendable silicon composite anode 200. The bendable silicon composite anode 200 includes a metallic foil 202, a Si layer 204, and an active transition layer 206 sandwiched between the metallic foil 202 and the Si Layer 204. The active transition layer 206 is in direct contact with both the metallic foil 202 and the Si Layer 204.

The metallic foil 202 may be formed of elemental copper (Cu), aluminum (Al), copper (Cu), nickel (Ni), iron (Fe), titanium (Ti), and any alloys thereof, including stainless steel and other suitable electrically conductive metals. The metallic foil 202 includes an inner surface 202A and an opposite outer surface 202B. Both of the surfaces of 202A, 202B are substantially planar and does not need to be pre-roughened. The thickness (T1) of the metallic foil 202, as measured between the inner surface 202A and the outer surface 202B, is between about 1 μm to 20 μm, preferably 3 μm to 12 μm. It should be appreciated that the metallic foil 202 includes a thickness that is thinner than the 5 μm thickness of metallic foils found in traditional negative electrodes. The relatively thinner metallic foil 202 enables a more bendable electrode and a battery cell 101 having a higher energy density than typical electrodes having thicker metallic foils. The use of relatively thinner metallic foil also enables cost and materials savings.

The active transition layer 206 includes greater than 0 to about 98 wt % of an active material such as graphite, greater than 0 to about 98 wt % of a carbon conductive additive, and greater than 0 to about 20 wt % of a binder. An active transition layer 206 comprising graphite as the active material is also referred to as a graphite transition layer 206. The natural surface roughness of the graphite transition layer 206 enables an intimate adhesion with the Si layer 204, while the binder helps to tightly bond with the metallic foil 202. The thickness (T2) of the active transition layer 206, as measured between the inner surface 202A of the metallic foil 202 and inner surface 204A of the Si Layer 204, is from about 1 μm to 60 μm, preferably from about 2 μm to 50 μm. The graphite transition layer 206 has an areal capacity loading of greater than 0 to 5 mAh/cm².

The active material may also include one or more of a carbonaceous material (e.g. hard carbon, soft carbon etc.), Li₄Ti₅O₁₂, metal oxide/sulfide (e.g., TiO₂, FeS and the likes), and other lithium-accepting anode materials in place of graphite. The carbon conductive additive includes one or more of carbon black, graphite, graphene, graphene oxide, Super P, acetylene black, carbon nanofibers, carbon nanotubes and other electronically conductive additives. The binder includes one or more of poly(vinylidene fluoride) (PVDF), poly(vinylidene fluoride-co hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

The Si layer 204 includes an inner surface 204A in direct contact with the active transition layer 206 and an opposite outer surface 204B. The thickness (T3) of the Si layer 204 as measured between the inner surface 204A and the outer surface 204B is from about 0.001 μm to 30 μm, preferably from 1 μm to 20 μm. The Si layer 20 includes an areal capacity loading of about 0.5 to 20 mAh/cm², preferably 4 mAh/cm². The Si layer 204 includes a homogenous thickness as it conforms to the contours of the active transition layer 206 to provide areal capacity. Homogenous thickness means a substantially consistent thickness having about 2˜20% variance.

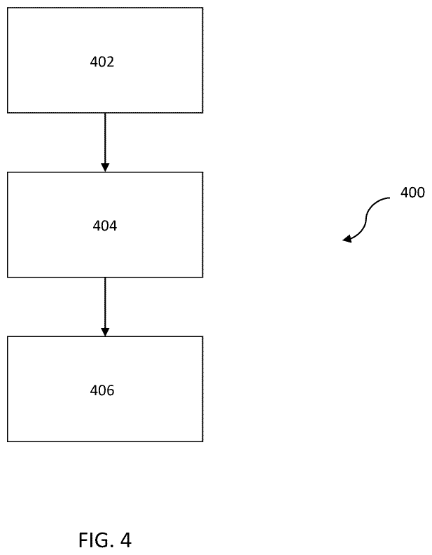

FIG. 3 is micrograph image 300 of a cross-section of the bendable silicon composite anode 200 having a graphite transition layer 206, also referred to as a silicon-graphite composite anode 200. The micrograph image shows the graphite transition layer 206 sandwiched between the Si layer 204 and the planar metallic foil 202. The graphite transition layer 206 includes a natural roughness sufficient to enable an intimate adhesion with the Si layer 204, while the binder in the graphite transition layer 206 helps to tightly bond with the planar metallic foil 202.

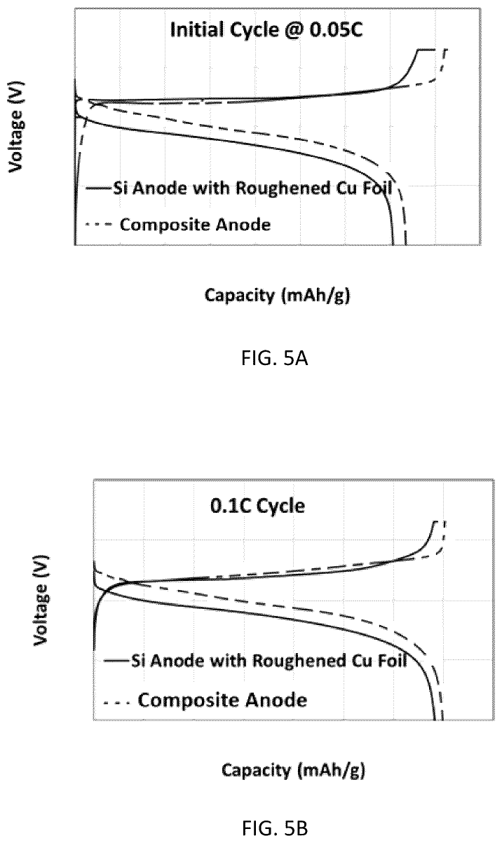

FIG. 4 is a block diagram 400 of a method of making the bendable silicon-graphite composite anode 200. At Block 402, a planar metallic foil is coated with a slurry of a graphite active material. At Block 404, the slurry coating on the metallic foil is dried and calendared to form a graphite layer transition layer 206. At Block 406, a layer Si 204 is deposited directly onto the graphite transition layer 206 using a magnetron sputtering. Magnetron sputtering is a technique used for thin film deposition. The deposition process involves ejecting material from a target onto natural contoured surface of the graphite transition layer 206.

Referring back to FIG. 1, the cathode includes about 30 to 98 wt % of a cathode active material, greater than 0 to about 50 wt % of solid electrolyte, greater than 0 to about 30 wt % of a conductive additive, and greater than 0 to about 20 wt % of a binder.

The cathode active material includes at least one of a layered oxide represented by the formula LiMeO₂, an olivine-type oxide represented by the formula LiMePO₄, a monoclinic-type oxide represented by the formula Li₃Me₂(PO₄)₃, a spinel-type oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof).

The cathode solid electrolyte includes at least one of an Oxide-based solid electrolyte. e.g., garnet type (e.g., Li₇La₃Zr₂O₁₂); Perovskite type (e.g., Li₃ₓLa_{2/3-x}TiO₃), NASICON type (e.g., Li_{1.4}Al_{0.4}Ti_{1.6}(PO₄)₃ and Li₁₊ₓAlₓGe₂₋ₓ(PO₄)₃), LISICON type (e.g., Li₂₊₂ₓZn₁₋ₓGeO₄); and Metal-doped or aliovalent-substituted oxide solid electrolyte. e.g., Al (or Nb)-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, Al-substituted perovskite, Li_{1+x+y}AlₓTi₂₋ₓSi_{y}P_{3-y}O₁₂.

The cathode conductive additive includes at least one of carbon black, graphite, graphene, graphene oxide, Super P, acetylene black, carbon nanofibers, carbon nanotubes and other electronically conductive additives.

The cathode binder material includes at least one of poly(vinylidene fluoride) (PVDF), poly(vinylidene fluoride-co-hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), styrene ethylene butylene styrene copolymer (SEBS) and so on.

The separator layer 106 includes at least one of the below materials, and the liquid electrolyte will wet the 5˜100% porosity of this layer (e.g., 90%). Polyolefin-Based Separator. e.g., polyacetylene: polypropylene (PP), polyethylene (PE), dual-layer type: PP-PE, three-layer type: PP-PE-PP. Cellulose separator, polyvinylidene fluoride (PVDF) membrane, and porous polyimide membrane. Ceramic-coated separator. e.g., SiO₂ coated PE. High-temp-stable separator. e.g., Polyimide (PI) nanofiber-based nonwovens, nano-sized Al₂O₃ and poly(lithium 4-styrenesulfonate)-coated polyethylene membrane, SiO₂ coated polyethylene (PE) separator, Co-polyimide-coated polyethylene separators, polyetherimides (PEI) (bisphenol-aceton diphthalic anhydride (BPADA) and para-phenylenediamine) separator, expanded polytetrafluoroethylene reinforced polyvinylidenefluoride-hexafluoropropylene separator, and sandwich-structured PVdF/PMIA/PVdF nanofibrous separators.

Solid electrolyte in solid electrolyte layer 108 includes at least one of Oxide-based solid electrolyte. e.g., garnet type (e.g., Li₇La₃Zr₂O₁₂); Perovskite type (e.g., Li₃ₓLa_{2/3-x}TiO₃), NASICON type (e.g., Li_{1.4}Al_{0.4}Ti_{1.6}(PO₄)₃ and Li₁₊ₓAlₓGe₂₋ₓ(PO₄)₃), LISICON type (e.g., Li₂₊₂ₓZn₁₋ₓGeO₄); and Metal-doped or aliovalent-substituted oxide solid electrolyte. e.g., Al (or Nb)-doped Li₇La₃Zr₂O₁₂, Sb-doped Li₇La₃Zr₂O₁₂, Ga-substituted Li₇La₃Zr₂O₁₂, Cr and V-substituted LiSn₂P₃O₁₂, Al-substituted perovskite, Li_{1+x+y}AlₓTi₂₋ₓSi_{y}P_{3-y}O₁₂. The Solid electrolyte in solid electrolyte layer 108 may include a Sulfide-based solid electrolyte. e.g., Li₂S—P₂S₅ system, Li₂S—P₂S₅-MOₓ system, Li₂S—P₂S₅-MSₓ system, LGPS (Li₁₀GeP₂S₁₂), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, lithium argyrodite Li₆PS₅X (X=Cl, Br, or I), Li_{9.54}Si_{1.74}P_{1.44}S_{11.7}Cl_{0.3} (25 mS/cm), Li_{9.6}P₃S₁₂, Li₇P₃S₁₁, Li₉P₃S₉O₃, Li_{10.35}Ge_{1.35}P_{1.65}S₁₂, Li_{10.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.166}S₄, LiI—Li₄SnS₄, and Li₄SnS₄. The Solid electrolyte in solid electrolyte layer may include a nitride-based solid electrolyte. e.g. LisN, Li₇PN₄, LiSi₂N₃. Hydride-based SE. e.g. LiBH₄, LiBH₄—LiX (X=Cl, Br, or I), LiNH₂, Li₂NH, LiBH₄—LiNH₂, Li₃AlH₆. Halide-based SE. e.g. LiI, Li₃InCl₆, Li₂CdCl₄, Li₂MgCl₄, Li₂Cdl₄, Li₂ZnI₄, Li₃OcI. Borate-based SE. e.g. Li₂B₄O₇, Li₂O—B₂O₃—P₂O₅.

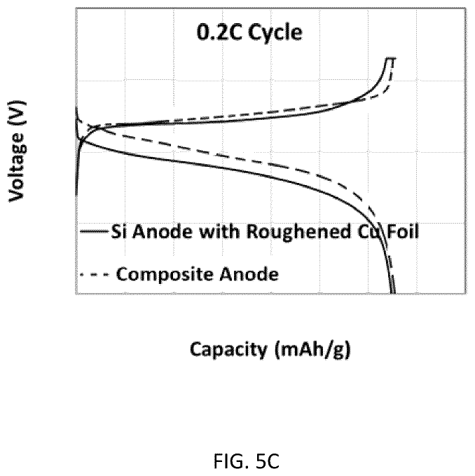

FIGS. 5A-5C are graphs showing the improved performance of the bendable silicon-graphite composite anode (represented by a dash-line) as compared to a traditional anode having a silicon layer in direct contact with the current collector (represented by a solid line). As shown in FIGS. 5A-5C, the bendable silicon-graphite composite anode exhibits higher discharge capacity and reduced voltage polarization potential at the current rate of 0.05° C., 0.1° C. and 0.2° C.

The bendable silicon-graphite composite anode 200 for R2R battery fabrication is enabled by employing a graphite transition layer 206 to ensure an excellent bonding with both Si layer 204 and a thinner planar metallic foil 202 as compared to the thickness of the traditional metallic foil used for direct deposit of the Si Layer. The graphite transition layer 206 ensures an excellent bonding with both the Si anode layer 204 and the thinner metallic foil 202. The natural surface roughness of graphite transition layer 206 enables an intimate adhesion with Si layer 204, while the binder in graphite transition layer 206 tightly bonds with the planar surface of the metallic foil 202. The graphite transition layer 206 provides an additional areal capacity for the battery cell 101 and guarantees a good electronic conduction for Si layer 204. As a result, this silicon-graphite composite anode 200 design delivers higher capacities than those of anodes having the Si layer disposed directly on roughened relatively thicker metallic foil.

Numerical data have been presented herein in a range format. “The term “about” as used herein is known by those skilled in the art. Alternatively, the term “about” includes +/−0.5%” of stated value. It is to be understood that this range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. While examples have been described in detail, those familiar with the art to which this disclosure relates will recognize various alternative designs and examples for practicing the disclosed method within the scope of the appended claims.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A battery cell, comprising:
an electrode including:
a metallic foil;
a silicon layer; and
an active transition layer sandwiched between the metallic foil and the silicon layer, wherein the active transition layer is in direct contact with the metallic foil and silicon layer.

2. The battery cell of claim 1, wherein the active transition layer comprises:
a graphite active material; and
a binder comprising at least one of poly(vinylidene fluoride) (PVDF), poly(vinylidene fluoride-co hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

3. The battery cell of claim 1, wherein the active transition layer comprises:
at least one of a carbonaceous material, a metal oxide, a metal sulfide, and Li₄Ti₅O₁₂; and
a binder comprising at least one of poly(vinylidene fluoride) (PVDF), poly(vinylidene fluoride-co hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

4. The battery cell of claim 2 further comprising a carbon conductive additive including at least one of: carbon black, graphite, graphene, graphene oxide, Super P, acetylene black, carbon nanofibers, and carbon nanotubes.

5. The battery cell of claim 2, wherein:
the metallic foil includes a thickness of 1 μm to less than 5 μm;
the silicon layer includes a thickness of 1 μm to 20 μm; and
the active transition layer includes a thickness of 2 μm to 50 μm.

6. The battery cell of claim 5, wherein the Si layer includes a substantially homogenous thickness conforming to a contour of the active transition layer.

7. The battery cell of claim 5, wherein the electrode is a negative electrode.

8. The battery cell of claim 5, wherein:
the active transition layer includes an areal capacity loading of greater than 0 to 5 mAh/cm²; and
the Si layer 20 includes an areal capacity loading of about 4 mAh/cm².

9. The battery cell of claim 5, wherein the metallic foil includes a non-roughened surface in direct contact with the active transition layer, wherein the binder bonds the transition layer onto the non-roughened surface.

10. The battery cell of claim 5, wherein the layer Si is deposited directly onto the active transition layer using a magnetron sputtering process to effectuate an intimate bond with the transition layer.

11. An electrode for a rechargeable battery, comprising:
a current collector,
a lithium-accepting host material, and
a transition layer sandwiched between the current collector and the lithium-accepting host material, wherein the transition layer includes a first surface in direct contact with the current collector and an opposite second surface in direct contact with the lithium-accepting host material.

12. The electrode for the rechargeable battery of claim 11, wherein the lithium-accepting host material is a silicon layer.

13. The electrode for the rechargeable battery of claim 12, wherein the current collector is a metallic foil comprising at least one of copper (Cu), Aluminum (AI), nickel (Ni), iron (Fe), titanium (Ti), and any alloys thereof including stainless steel.

14. The electrode for the rechargeable battery of claim 12, wherein the transition layer comprises:
a graphite active material; and
a binder.

15. The electrode for the rechargeable battery of claim 14, wherein the binder comprises at least one of poly(vinylidene fluoride) (PVDF), poly(vinylidene fluoride-co hexafluoropropylene) (PVdF-HFP), poly(tetrafluoroethylene) (PTFE), sodium carboxymethyl cellulose (CMC), styrene-butadiene rubber (SBR), nitrile butadiene rubber (NBR), and styrene ethylene butylene styrene copolymer (SEBS).

16. The electrode for the rechargeable battery of claim 14, further comprising a conductive additive including at least one of carbon black, graphite, graphene, graphene oxide, Super P, acetylene black, carbon nanofibers, and carbon nanotubes.

17. The electrode for the rechargeable battery of claim 14, wherein the silicon layer includes a homogenous thickness of 1 μm to 20 μm, the transition layer includes a thickness of 2 μm to 50 μm, and the current collector includes a thickness of 1 μm to less than 5 μm.

18. A lithium ion battery comprising a negative electrode, wherein the negative electrode comprises:
a current collector;
a silicon layer; and
a graphite transition layer sandwiched between the current collector and the silicon layer, wherein the graphite transition layer is in direct contact with the current collector and the current collector; and
wherein the graphite transition layer includes a binder.

19. The lithium ion battery of claim 18, wherein:
the silicon layer includes a substantially homogenous thickness of 1 μm to 20 μm;
the graphite transition layer includes a thickness of 2 μm to 50 μm; and
the current collector includes a thickness of 1 μm to less than 5 μm.

20. The lithium ion battery of claim 19, wherein:
the graphite transition layer includes an areal capacity loading of greater than 0 to 5 mAh/cm²; and
the Si layer 20 includes an areal capacity loading of about 4 mAh/cm².
